(19) United States
(12) Patent Application Publication
(10) Pub. No.: US 2025/0151916 A1
(43) Pub. Date: May 15, 2025

(54) CONTOURED THERAPEUTIC WEDGE WITH ATTACHMENT MEANS FOR SUPPLEMENTAL PILLOWS

(71) Applicant: Justin Matthew Wymore, Austin, TX (US)

(72) Inventor: Justin Matthew Wymore, Austin, TX (US)

(21) Appl. No.: 18/949,775

(22) Filed: Nov. 15, 2024

Related U.S. Application Data
(60) Provisional application No. 63/599,168, filed on Nov. 15, 2023.

(51) Int. Cl. A47C 20/02; A47G 9/10; B32B 3/26; B32B 5/18; B32B 5/32

(52) U.S. Cl. CPC A47C 20/027; A47C 20/023; A47G 9/1072; B32B 3/263; B32B 5/18; B32B 5/32; A47G 2009/1018; B32B 2266/06; B32B 2266/08; B32B 2535/00

(57) ABSTRACT

A contoured therapeutic cushion assembly includes a wedge cushion; a base panel; and a head rest having a lower surface joined to the base panel. The wedge cushion has a top surface and a bottom surface. The top surface is disposed at an angle relative to the bottom surface so that the top surface and the bottom surface join at a first end. An elongated concave surface joins the top surface and the bottom surface opposite the first end. A base panel extends from a lower edge of the elongated concave surface. The head rest has an elongated surface within which a longitudinally extending recess is formed. The elongated concave surface, the base panel, and the longitudinally extending recess collectively define a channel to receive at least a portion of a user's arm.

### CROSS-REFERENCE TO RELATED APPLICATION

This application claims the benefit of priority of U.S. provisional application No. 63/599,168, filed Nov. 15, 2023, the contents of which are herein incorporated by reference.

### BACKGROUND OF THE INVENTION

The present invention relates to a therapeutic pillow and, more particularly, to a contoured therapeutic wedge with attachment means for supplemental pillows.

Common ailments like acid reflux or gastroesophageal reflux disease (GERD), heartburn, headaches, and snoring can be improved by elevating the upper body while sleeping. Shoulder pain can result from excessive pressure on the shoulder when sleeping on one's side. An elevated sleeping position may also improve blood circulation and oxygen absorption. Only one product is available on the market to address these problems, called Medcline®. It has a circular hole in the middle of the area where the head sits. It is uncomfortable and requires the user to slip their arm in and out of the opening, providing a poor sleep experience every time the user wants to move or change positions. Its incline is also very steep, causing the person to slide down the wedge throughout the night, leading to continuous sleep interruption.

Moreover, some people prefer sleeping with pillows/body pillows under or around their bodies. However, if the sleeper throws the pillow off in the middle of the night, it can fall on the floor and create a tripping hazard in the middle of the night. However, currently available sleeping wedges have no way to attach the pillows to keep them from falling.

As can be seen, there is a need for a sleeping aid that helps relieve discomfort and provides deep, restorative sleep.

### SUMMARY OF THE INVENTION

In one aspect of the present invention, a contoured therapeutic cushion assembly comprises a wedge cushion including a top surface and a bottom surface, wherein the top surface is disposed at an angle relative to the bottom surface so that the top surface and the bottom surface join at a first end; and an elongated concave surface joining the top surface and the bottom surface opposite the first end; a base panel extending from a lower edge of the elongated concave surface; and a head rest having a lower surface joined to the base panel, and an elongate surface having a longitudinally extending recess formed therein; wherein the elongate concave surface, the base panel, and the longitudinally extending recess collectively define a channel configured to receive at least a portion of a user's arm therein.

These and other features, aspects and advantages of the present invention will become better understood with reference to the following drawings, description, and claims.

### BRIEF DESCRIPTION OF THE DRAWINGS

FIG. 1 is a perspective view of a wedge and head cushion assembly according to a first embodiment of the present invention;

FIG. 2 is a top plan view thereof;

FIG. 3 is a front elevation view thereof;

FIG. 4 is a side elevation view thereof;

FIG. 5 is an exploded view thereof;

FIG. 6 is a sectional view thereof;

FIG. 7 is another top plan view thereof, shown in use in a first position;

FIG. 8 is another top plan view thereof, shown in use in a second position;

FIG. 9 is another side elevation view thereof, shown in use in a third position;

FIG. 10 is another perspective view thereof, shown in use with a supplementary pillow;

FIG. 11 is another perspective view thereof, shown in use with a supplementary body pillow;

FIG. 12 is a perspective view of a wedge and head cushion assembly according to a second embodiment of the present invention;

FIG. 13 is a sectional view thereof;

FIG. 14 is a perspective view of a wedge and head cushion assembly according to a third embodiment of the present invention;

FIG. 15 is a sectional view thereof;

FIG. 16 is a perspective view of a wedge and head cushion assembly according to a fourth embodiment of the present invention; and

FIG. 17 is a sectional view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a therapeutic foam wedge with cutouts and contouring that relieves shoulder pain and promotes better sleep.

Without limiting the invention, in an exemplary embodiment, the overall assembly may have a length of about 44″, a width of about 30″, and a height of about 7.6′ to about 8.5″.

A user's arm and shoulder drop into the wedge contouring and cutouts at an upper head area, falling into a natural position, while the wedge props their torso up at an incline. The open cutout allows the person to shift and change positions without having to pull their arm out of a cutout like the Medcline®.

The wedge is generally provided with attachment means for pillows and body pillows so that the user can easily throw the pillow off in the middle of the night to hang along the side of the bed. The attachment means may comprise a hook and loop fastener such as Velcro®. For example, hook side material may extend from the wedge as an attachment point for pillows/body pillows. This allows an individual to place the pillows/body pillows under their arms, legs, etc. for a more relaxing and pressure-relieving sleep. The attachment means may be provided on both sides of the wedge, enabling the user to change the side where pillows/body pillows are positioned. Without limiting the dimensions, the attachment means of an exemplary embodiment may be about 24″ long

The closed cell foam is the top layer of the wedge. It sits on top of and is attached to the open cell foam, the base of the wedge. The closed cell foam provides a softer cushion for the body, while the open cell foam provides supportive structure for the body/upper torso. Without limiting the dimensions, the top layer of an exemplary embodiment of the wedge portion of the assembly may have a thickness of about 1″, a length of about 28.5″, and a width of about 30″.

To make the contoured wedge disclosed herein, a manufacturer may make molds for the closed cell foam and the open cell foam. They may inject the molds with the respective foam solutions. Once the foam has formed, the closed cell foam may be glued onto the open cell foam, creating a single wedge. A hook side component of a hook-and-loop closure may then be attached to both sides of the wedge, creating an attachment point for supplemental pillows/body pillows.

To use the wedge, the user may lay down on it while in bed resting or sleeping. When an individual lies on the wedge, their arm/shoulder falls into a cutout, putting it in a more natural and pressure-relieving position while they sleep. Without limiting the dimensions, the cutout according to an embodiment of the present invention may have a base measuring about 4″×about 30″×about 0.5″.

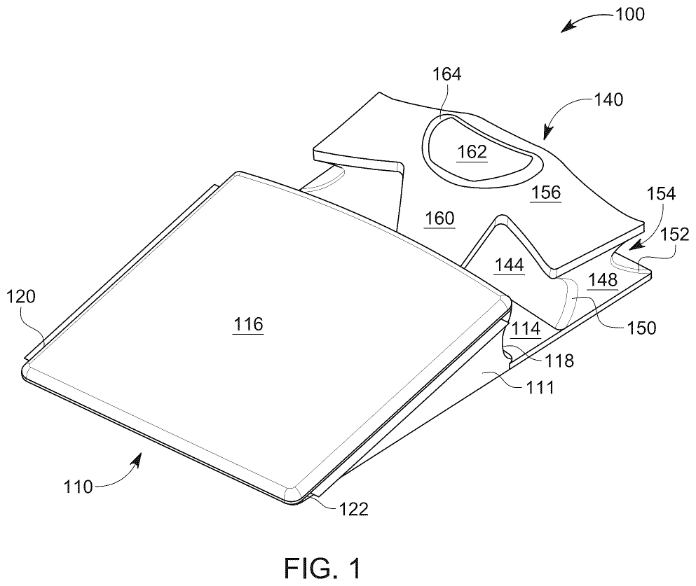

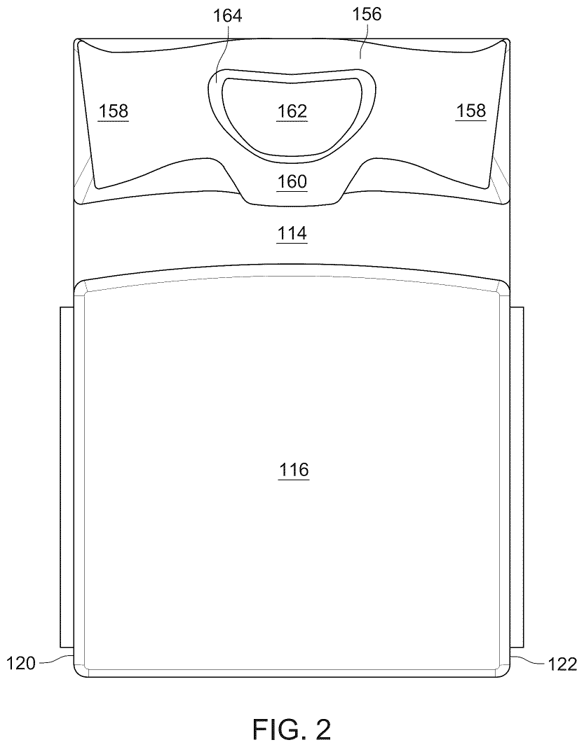

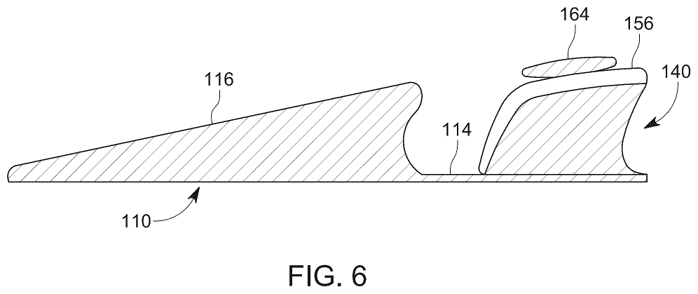

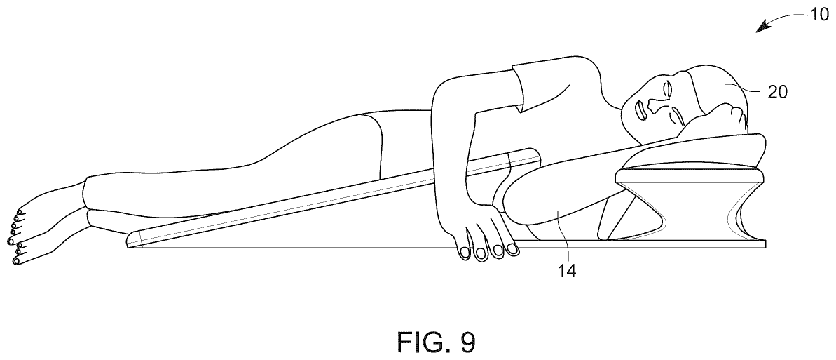

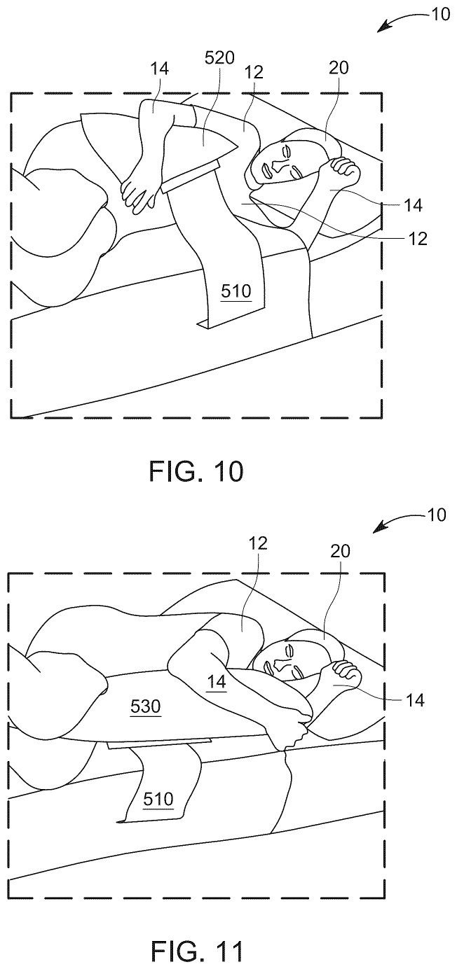

Referring to FIGS. 1 through 17, FIGS. 1-6 illustrate a wedge and head cushion assembly 100 according to a first embodiment of the present invention, comprising a wedge cushion 110 and a head cushion 140 coupled to a base 114, as illustrated in FIG. 1. A channel is formed between a curved surface 118 the wedge cushion 110, a curved surface 144 of the head cushion 140, and an upper surface of the base 114; see FIGS. 2, 4, and 6. The channel is configured to accommodate a user's 10 shoulder 12 and/or arm 14, as shown in FIGS. 7-11, discussed below.

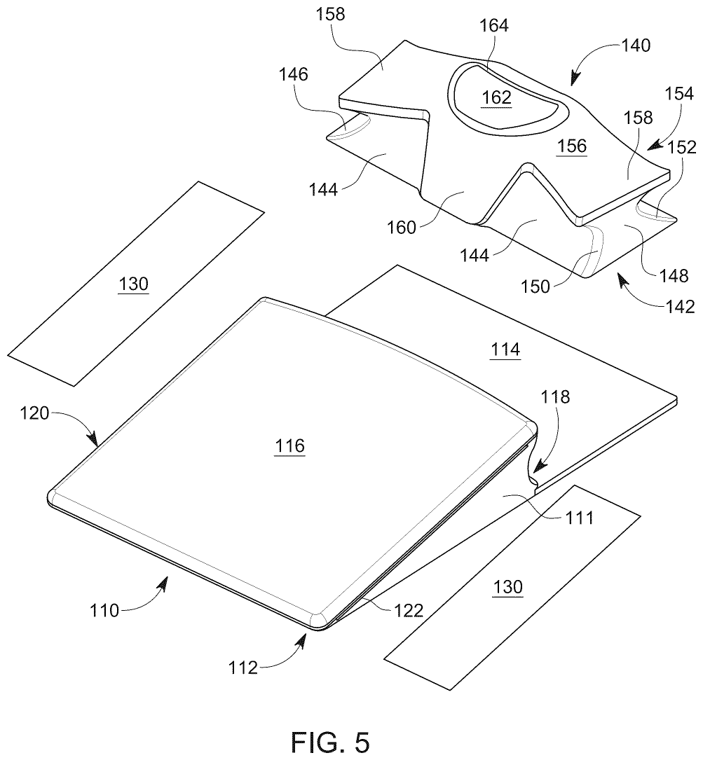

The wedge cushion 110 generally comprises a rectangular top surface 116, a rectangular bottom surface 112, substantially triangular side surfaces 111, and an elongated concave front surface 118. An attachment means 120, 122, which may include, for example, hook and loop fasteners, extends from the intersection of the top surface 116 and the side surface 111 on each side. A bottom edge of the concave surface 118 is joined to the base 114. As illustrated in FIG. 5, an attachment band 130 may be coupled to the attachment means 120, 122 on either or both sides.

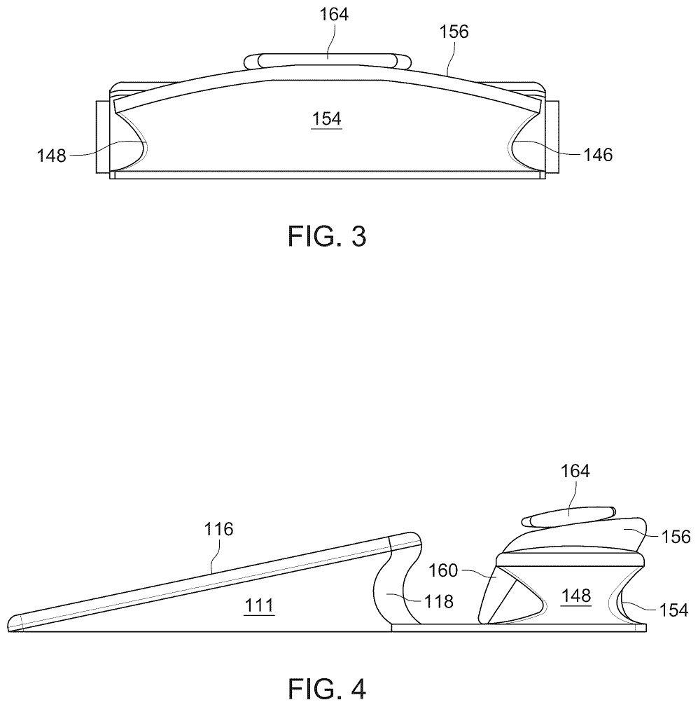

The head cushion 140 has a substantially rectangular prismatic shape comprising a bottom surface 142, a concave front surface 154, a concave rear surface 144, and side surfaces 146, 148 having arcuate edges 150, 152 joining the front surface 154 and the rear surface 144. The side surfaces 146, 148 may, for example, have a height of about 4″ to about 4.5″. The cushion 140 may have a maximum height of about 7.8″ to about 8.5″ in some cases. A top panel 156 has side panels 158 extending to the side surfaces and a middle panel 160 that extends into the channel down to the base 114. The middle panel 160 may have an upper length at a junction with the side panels of about 10″ and may have an edge about 6″ long contacting the base 114. A central cushion, basin, bowl, or concavity 162 with a rim 164 (see FIG. 3) is configured to receive a user's head 20, as shown FIGS. 7-9. The cushion 162 may be substantially circular, oval, or triangular, for example. In an example, the cushion 162 may have dimensions of about 11.5″×6.5″×about 1″.

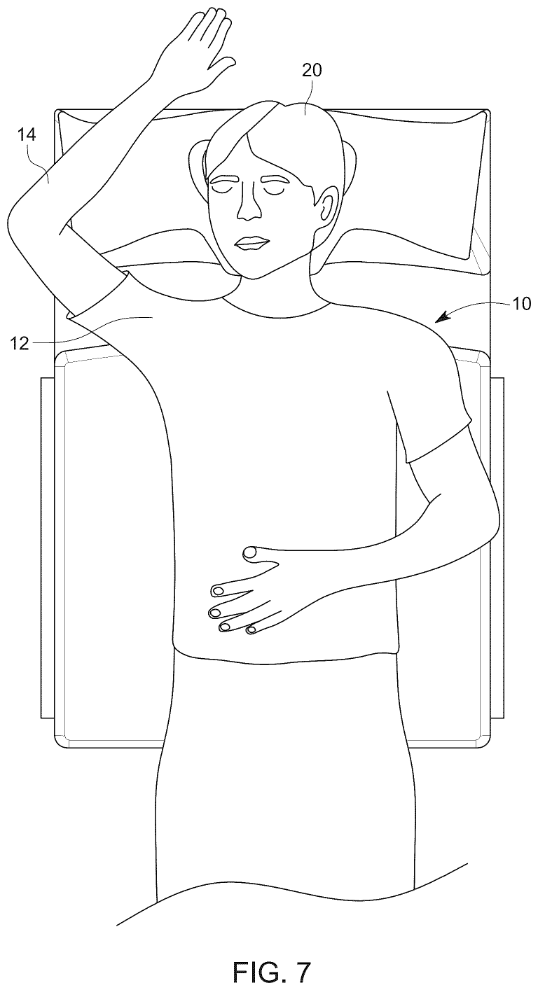

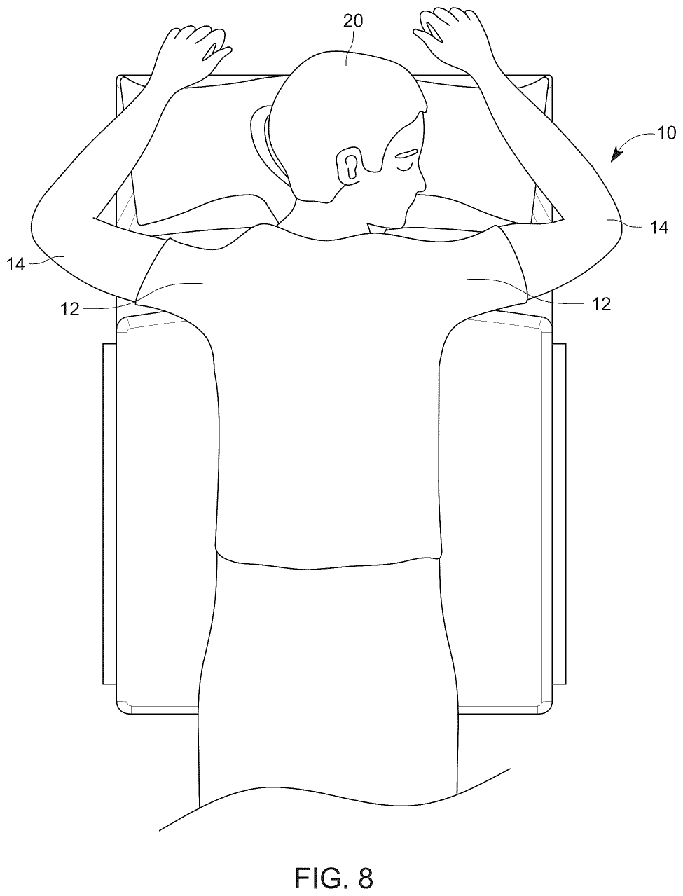

FIG. 7 illustrates use of the assembly 100 in a supine position, FIG. 8 illustrates use of the assembly 100 in a prone position, and FIG. 9 illustrates use of the assembly 100 in a side-sleeping position. Note that the user's 10 head 20 rests in the concavity 162, the user's 10 shoulder or shoulders 12 rests in the channel, and the user's arm or arms 14 may be cradled in one or more concave surfaces 118, 144, 146, 148, 154. If a supplementary pillow 520 or body pillow 530 is used, the user 10 may attach the pillow 520, 530 to a strap 510 and fasten the strap 510 to the fastening means 120, 122. The strap 510 keeps the pillow 520, 530 accessible, for example, if it falls while the user 10 is sleeping.

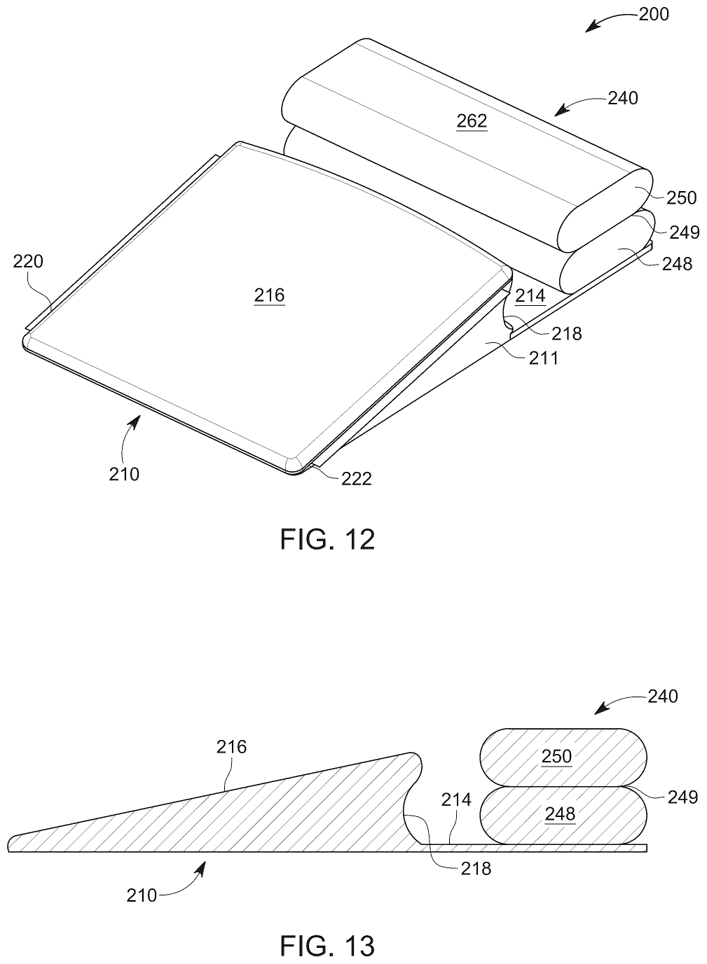

An assembly 200 according to another embodiment of the present invention is shown in FIGS. 12-13. A wedge 210 with side surfaces 211 and a top surface 216 has attachment means 220, 222 at the intersections, as discussed above, as well as an elongated concave surface 218 joined to the side surfaces 211 and the top surface 216. A base 214 is joined to a bottom portion of the concave surface 218. Stacked cushions 248, 250 each having a flattened cylindrical shape form a head portion 240 that rests on or is fastened to the base 214. A junction 249 between the cushions 248, 250 may be formed by physical abutment of the cushions 248, 250, or the cushions 248, 250 may be affixed together. A channel is formed between the stacked cushions 248, 250 and the concave surface 218 of the wedge 210. An upper surface 262 is configured to receive the user's head 20. Without limiting the invention, each of the stacked cushions 248, 250 may have a dimensions, for example, of about 30″×11.5″×4″.

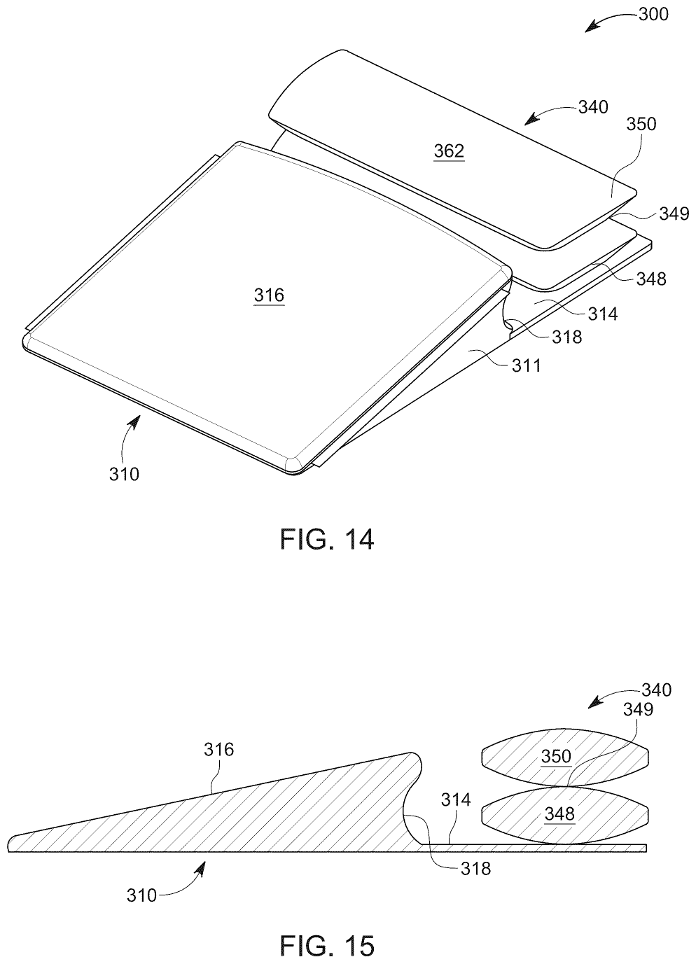

FIGS. 14-15 show another assembly 300 according to an embodiment of the present invention. A wedge 310 with side surfaces 311 and a top surface 316 has attachment means at the intersections, as discussed above, as well as a concave surface 318 joined to the side surfaces 311 and the top surface 316. A base 314 is joined to a bottom portion of the concave surface 318. Stacked cushions 348, 350 having a substantially ovoid cross-section with a junction 349 therebetween form a head portion 340 that rests on or is fastened to the base 314. An upper surface 362 is configured to receive the user's head 20. Without limiting the invention, each of the stacked cushions 348, 350 may have a dimensions, for example, of about 30″×11.5″×4″.

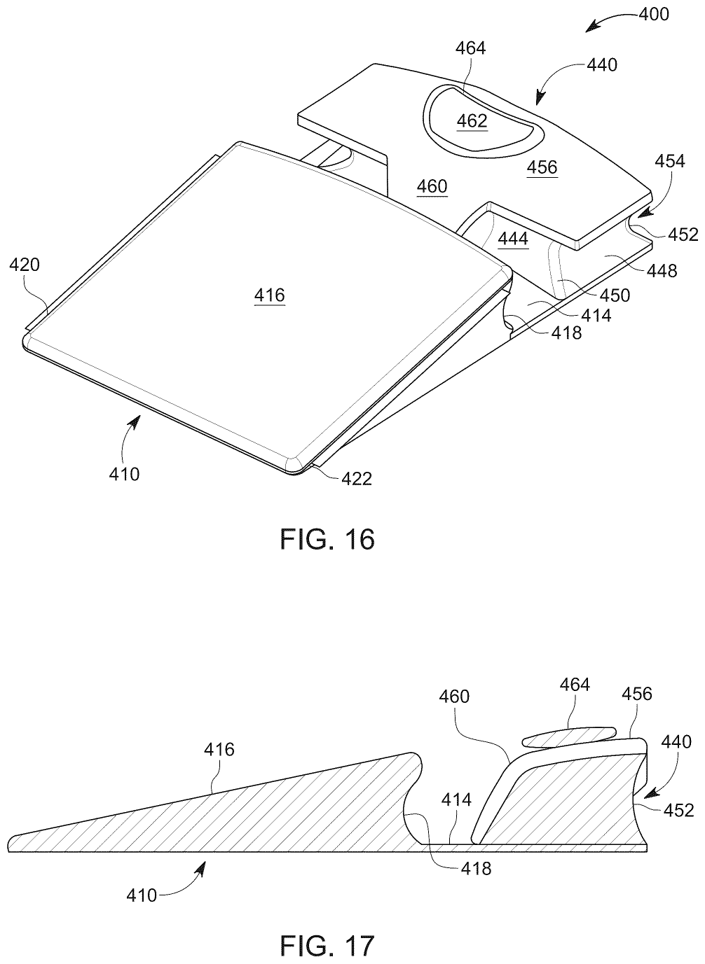

An assembly 400 according to a fourth embodiment is shown in FIGS. 16-17, having a wedge 410 with a top surface 416, a curved front surface 418, and attachment means 420, 422 similar to the previously discussed embodiments, and a base 414 upon which a head portion 440 rests or is affixed. Similar to the head portion 140 shown in FIG. 1, four curved sidewalls 444, 448, 454 are joined by curved edges 450, 452. A substantially T-shaped panel 456 atop the sidewalls 444, 448, 454 has a flap 460 descending into a channel formed by the base 414, the curved wall 418 of the wedge and a parallel curved wall 444 of the head portion 440. A central cushion 462 with a rim 464 is centered upon the T-shaped panel 456 and is configured to receive the user's head 20. The fourth embodiment differs from the first embodiment at least in that the head portion of the fourth embodiment is less curved.

It should be understood, of course, that the foregoing relates to exemplary embodiments of the invention and that modifications may be made without departing from the spirit and scope of the invention as set forth in the following claims.

What is claimed is:

1. A contoured therapeutic cushion assembly, comprising:
a wedge cushion including a top surface and a bottom surface, wherein the top surface is disposed at an angle relative to the bottom surface so that the top surface and the bottom surface join at a first end; and an elongated concave surface joining the top surface and the bottom surface opposite the first end;
a base panel extending from a lower edge of the elongated concave surface; and
a head rest having a lower surface joined to the base panel, and an elongate surface having a longitudinally extending recess formed therein;
wherein the elongate concave surface, the base panel, and the longitudinally extending recess collectively define a channel configured to receive at least a portion of a user's arm therein.

2. The contoured therapeutic cushion assembly of claim 1, wherein the wedge cushion has a layered configuration, with a closed-cell foam layer disposed upon an open-cell foam layer.

3. The contoured therapeutic cushion assembly of claim 1, wherein the head rest has a layered configuration, with a closed-cell foam layer disposed upon an open-cell foam layer.

4. The contoured therapeutic cushion assembly of claim 1, further comprising a central cushion joined to an upper surface of the head rest and configured to receive a user's head.

5. The contoured therapeutic cushion assembly of claim 1, wherein the head rest has concave surfaces on at least two sides.

6. The contoured therapeutic cushion assembly of claim 1, wherein the head rest further comprises a substantially T-shaped top surface having a leg that extends into the channel.

7. The contoured therapeutic cushion assembly of claim 1, wherein the head rest comprises stacked elongated cushions.

8. The contoured therapeutic cushion assembly of claim 7, wherein the stacked elongated cushions have a substantially ovoid cross-section with a junction therebetween.

9. The contoured therapeutic cushion assembly of claim 7, wherein the stacked elongated cushions have a substantially flattened cylinder cross-section.

10. The contoured therapeutic cushion assembly of claim 1, further comprising attachment means extending longitudinally along opposite edges of the top surface.

11. The contoured therapeutic cushion assembly of claim 10, wherein the attachment means includes hook and loop fasteners.

12. The contoured therapeutic cushion assembly of claim 10, further comprising a supplemental cushion removably fastened to the attachment means.
